(19) United States
(12) Patent Application Publication
(10) Pub. No.: US 2019/0320574 A1
(43) Pub. Date: Oct. 24, 2019

(54) SYSTEM FOR CREATING SOIL COMPACTION MAPS AND ASSOCIATED METHODS FOR CONTROLLING THE OPERATION OF A TILLAGE IMPLEMENT

(71) Applicant: CNH Industrial America LLC, New Holland, PA (US)

(72) Inventors: Nicholas N. Andrejuk, Normal, IL (US); Tracey D. Meiners, Mackinaw, IL (US)

(73) Assignee: CNH INDUSTRIAL AMERICA LLC

(21) Appl. No.: 15/955,860

(22) Filed: Apr. 18, 2018

(51) Int. Cl. A01B 79/02; A01B 33/08; A01B 33/16; A01B 37/00; A01B 63/32; G01L 1/26; G06F 17/30

(52) U.S. Cl. CPC A01B 79/02; A01B 33/087; A01B 33/16; G06F 17/30241; A01B 63/32; G01L 1/26; A01B 37/00

(57) ABSTRACT

In one aspect, a system for creating a soil compaction map for a field may include a plurality of sensors, with each sensor being provided in operative association with one of the plurality of fluid-driven actuators. Each sensor may be configured to detect a force associated with its respective fluid-driven actuator as associated shanks engage the ground with movement of the tillage implement across the field. Furthermore, a controller of the system may be configured to identify one or more locations of a compaction layer within the field based on sensor data received from the plurality of sensors associated with the detected forces. Additionally, the controller may further be configured to create a soil compaction map for the field based on the identified one or more locations of the compaction layer.

### FIELD

The present disclosure generally relates to tillage implements and, more particularly, to systems for creating a soil compaction map for a field across which a tillage implement is moved and associated methods for controlling the operation of the tillage implement.

### BACKGROUND

It is well known that, to attain the best agricultural performance from a field, a farmer must cultivate the soil, typically through a tillage operation. Modern farmers perform tillage operations by pulling a tillage implement behind an agricultural work vehicle, such as a tractor. Tillage implements typically include a plurality of shanks configured to penetrate the soil to a particular depth. In this respect, the ground engaging tools may be pivotally coupled to a frame of the tillage implement. Tillage implements may also include biasing elements, such as springs, configured to exert downward biasing forces on the shanks. This configuration may allow the shanks to maintain the particular depth of soil penetration as the agricultural work vehicle pulls the tillage implement through the field. Additionally, this configuration may also permit the shanks to pivot out of the way of rocks or other impediments in the soil, thereby preventing damage to the shanks or other components on the implement (e.g., the frame of the implement).

Certain portions of the field may include a compacted or otherwise compressed top layer of soil. Such a compacted soil layer may make tillage operations difficult. For example, compacted soil in certain portions of the field may exert a great enough force on the shanks to overcome the downward biasing force otherwise applied to the shanks. In this respect, the shanks may pivot relative to the implement frame such that the depth of soil penetration varies. In some instances, the soil compaction layer may be caused by factors within the control of the farmer, such as heavy vehicle traffic.

Accordingly, an improved system for mapping compaction layers within the soil and associated methods for controlling the operation of a tillage implement would be welcomed in the technology.

### BRIEF DESCRIPTION

Aspects and advantages of the technology will be set forth in part in the following description, or may be obvious from the description, or may be learned through practice of the technology.

In one aspect, the present subject matter is directed to a system for creating a soil compaction map for a field. The system may include a tillage implement having a frame and a plurality of shanks coupled to the frame. The tillage implement may further include a plurality of fluid-driven actuators, with each fluid-driven actuator being coupled between the frame and a respective one of the plurality of shanks. The system may also include a plurality of sensors, with each sensor being provided in operative association with a respective one of the plurality of fluid-driven actuators. Each sensor may be configured to detect a force associated with its respective fluid-driven actuator as the shanks engage the ground with movement of the tillage implement across the field. Furthermore, the system may include a controller communicatively coupled to the plurality of sensors. The controller may be configured to identify one or more locations of a compaction layer within the field based on sensor data received from the plurality of sensors associated with the detected forces. Additionally, the controller may further be configured to create a soil compaction map for the field based on the identified one or more locations of the compaction layer.

In another aspect, the present subject matter is directed to a method for controlling the operation of a tillage implement. The tillage implement may include a frame and a plurality of shanks coupled to the frame. The tillage implement may further include a plurality of fluid-driven actuators, with each fluid-driven actuator being coupled between the frame and a respective one of the plurality of shanks. The method may include monitoring, with a computing device, a force associated with one or more of the plurality of actuators as the tillage implement is being moved across a field such that the shanks engage the ground. The method may also include comparing, with the computing device, the monitored force to a threshold force to identify one or more locations of a compaction layer within the field. Furthermore, the method may include initiating, with the computing device, a control action associated with adjusting an operational parameter of the tillage implement upon identifying one or more locations of the compaction layer within the field.

These and other features, aspects and advantages of the present technology will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present technology, including the best mode thereof, directed to one of ordinary skill in the art, is set forth in the specification, which makes reference to the appended figures, in which:

FIG. 1 illustrates a perspective view of one embodiment of a tillage implement in accordance with aspects of the present subject matter;

FIG. 2 illustrates a side view of one embodiment of a shank assembly of a tillage implement in accordance with aspects of the present subject matter, particularly illustrating a fluid-driven actuator coupled between a frame of the tillage implement and a shank of the shank assembly;

FIG. 3 illustrates a schematic view of one embodiment of a system for creating a soil compaction map for a field in accordance with aspects of the present subject matter;

FIG. 4 illustrates an example soil compaction map for a field in accordance with aspects of the present subject matter, particularly illustrating regions of a compaction layer within the field; and

FIG. 5 illustrates a flow diagram of one embodiment of a method for controlling the operation of a tillage implement in accordance with aspects of the present subject matter.

Repeat use of reference characters in the present specification and drawings is intended to represent the same or analogous features or elements of the present technology.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to systems for creating a soil compaction map for a field across which a tillage implement is moved. Specifically, in several embodiments, a controller of the disclosed system may be configured to identify one or more locations of a compaction layer within the field based on sensor data received from a plurality of sensors, with each sensor being provided in operative association with a corresponding shank of the implement. Such sensor data may be indicative of the forces within one or more fluid-driven actuators coupled between a frame of the tillage implement and a respective shank of the implement. For instance, in one embodiment, the controller may be configured to compare the monitored force(s) to a threshold force to identify the location(s) of the compaction layer within the field. Thereafter, the controller may be configured to create a soil compaction map for the field based on the identified location(s) of the compaction layer. For example, the soil compaction map may associate the location(s) of the soil compaction layer with corresponding geographical location(s) within the field.

Moreover, aspects of the present subject matter are also directed to associated methods for controlling the operation of the tillage implement as the implement is moved across the field. More specifically, upon identifying the location(s) of the compaction layer within the field, the controller may be configured to initiate a control action associated with adjusting an operational parameter of the tillage implement. In one embodiment, such control action may be adapted to facilitate removal of the compaction layer within the field. For example, the controller may be configured to adjust the speed at which the tillage implement is moved across the field. In addition (or as an alternative thereto), the controller may be configured to adjust the penetration depth of one or more of the shanks when the monitored force(s) associated with the respective actuator(s) exceeds the threshold force.

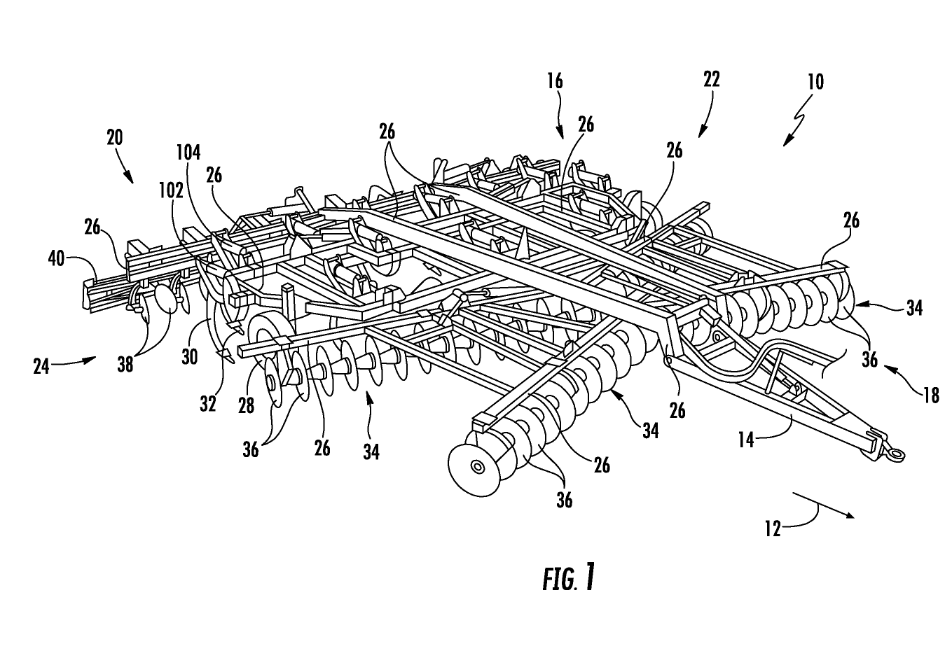

Referring now to the drawings, FIG. 1 illustrates a perspective view of one embodiment of a tillage implement 10 in accordance with aspects of the present subject matter. As shown in the illustrated embodiment, the implement 10 may be configured to be towed across a field in a direction of travel (e.g., as indicated by arrow 12) by a work vehicle (not shown), such as a tractor or other agricultural work vehicle. The implement 10 may be coupled to the work vehicle via a hitch assembly 14 or using any other suitable attachment means.

The implement 10 may also include an implement frame 16. As shown, the frame 16 may extend longitudinally between a forward end 18 and an aft end 20. The frame 16 may also extend laterally between a first side 22 and a second side 24. In this respect, the frame 16 generally includes a plurality of structural frame members 26, such as beams, bars, and/or the like, configured to support or couple to a plurality of components. Additionally, a plurality of wheels 28 (one is shown) may be coupled to the frame 16 to facilitate towing the implement 10 in the direction of travel 12.

In several embodiments, the frame 16 may configured to support a plurality of shanks 30, 32 configured to rip or otherwise till the soil as the implement 10 is towed across the field. In this regard, the shanks 30, 32 may be configured to engage the soil as the tillage implement 10 is towed across the field. As will be described below, the shanks 30, 32 may be configured to be pivotally mounted to the frame 16 to allow the shanks 30, 32 to pivot out of the way of rocks or other impediments in the soil. As shown, the shanks 30, 32 may be spaced apart from one another laterally between the first side 22 and the second side 24 of the frame 16. It should be appreciated that, although only two shanks 30, 32 are identified in FIG. 1, the implement 10 may generally include any number of shanks mounted on the frame 16.

In one embodiment, the frame 16 may be configured to support one or more gangs or sets 34 of disc blades 36. As is generally understood, each disc blade 36 may, for example, include both a concave side (not shown) and a convex side (not shown). Moreover, the various gangs 34 of disc blades 36 may be oriented at an angle relative to the travel direction 12 to promote more effective tilling of the soil. In the embodiment shown in FIG. 1, the implement 10 includes four gangs 34 of disc blades 36, with each gang 34 being coupled to the frame 16 longitudinally forward of the shanks 30, 32. However, it should be appreciated that, in alternative embodiments, the implement 10 may include any other suitable number of disc gangs 34, such as more of fewer than four disc gangs 34. Furthermore, in one embodiment, the disc gangs 34 may be mounted longitudinally aft of the shanks 30, 32.

Additionally, as shown in FIG. 1, in one embodiment, the frame 16 may be configured to support other ground engaging tools. For instance, in the illustrated embodiment, the frame 16 is configured to support a plurality of leveling blades 38 and rolling (or crumbler) basket assemblies 40. However, in other embodiments, any other suitable ground-engaging tools may be coupled to and supported by the frame 16, such as a plurality closing discs.

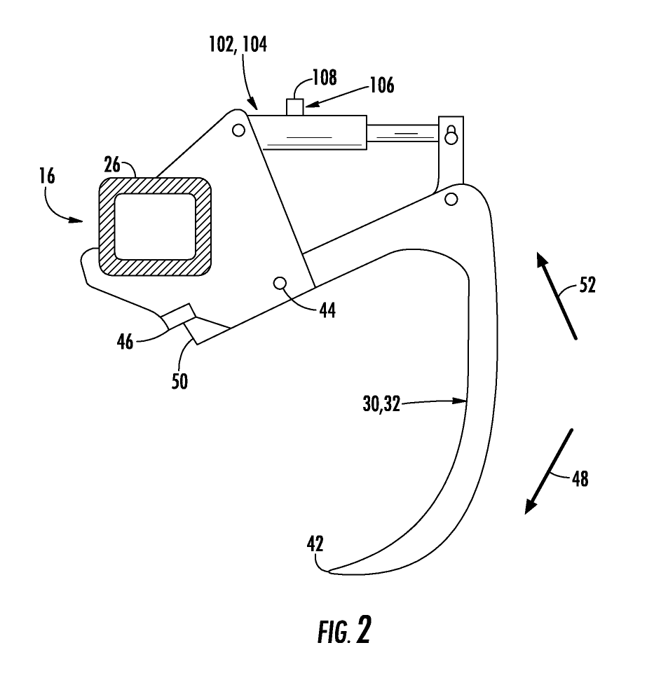

Referring now to FIG. 2, a side view of one embodiment of one of the shanks 30, 32 of the tillage implement 10 described above with reference to FIG. 1 is illustrated in accordance with aspects of the present subject matter. As indicated above, the shanks 30, 32 may be configured to till or otherwise cultivate the soil. In this regard, one end of each shank 30, 32 may include a tip 42 configured to penetrate into or otherwise engage the ground as the implement 10 is pulled across the field. The opposed end of each shank 30, 32 may be pivotally coupled to the implement frame 16, such as at pivot point 44. In one embodiment, the various shanks 30, 32 of the implement 10 may be configured as rippers. However, one of ordinary skill in the art would appreciate that the shanks 30, 32 may, instead, be configured as chisels, sweeps, tines, or any other suitable type of shanks. Furthermore, it should be appreciated that other shanks coupled to the frame 16 may have the same or a similar configuration to as the shank 30, 32 shown in FIG. 2.

In several embodiments, the implement 10 may also include a fluid-driven actuator 102, 104 coupled between the frame 16 and each shank 30, 32. For example, as shown in FIG. 1, a first actuator 102 may be coupled between the implement frame 16 and shank 30, while a second actuator 104 may be coupled between the frame 16 and shank 32. As particularly shown in FIG. 2, each actuator 102, 104 may be configured to bias its corresponding shank 30, 32 to a predetermined shank position (e.g., a home or base position) relative to the frame 16. In general, the predetermined shank position may correspond to the shank position at which each shank 30, 32 penetrates the soil to a desired depth. In several embodiments, the predetermined shank position for each shank 30, 32 may be set by a corresponding mechanical stop 46. In operation, each actuator 102, 104 may permit relative movement between its respective shank 30, 32 and the frame 16. For example, each actuator 102, 104 may be configured to bias its corresponding shank 30, 32 to pivot relative to the frame 16 in a first pivot direction (e.g., as indicated by arrow 48 in FIG. 2) until its respective end 50 contacts the corresponding stop 46. Each actuator 102, 104 may also allow its corresponding shank 30, 32 to pivot away from it corresponding predetermined shank position (e.g., to a shallower depth of penetration), such as in a second pivot direction (e.g., as indicated by arrow 52 in FIG. 2) opposite the first pivot direction 48, when encountering rocks or other impediments in the field.

Furthermore, the implement 10 may also include a plurality of sensors 106, with each sensor 106 being provided in operative association with a respective one of the fluid-driven actuators 102, 104. In general, each sensor 106 may be configured to detect the force associated with its respective actuator 102, 104 as the shanks 30, 32 are pulled through the soil. In one embodiment, a sensor 106 is provided in operative association with each of the actuators 102, 104. However, it should be appreciated that the sensors 106 may be provided in operative association with any of the shanks coupled to the implement frame 16, such as only one of the actuators 102, 104 or actuators coupled between other shanks and the implement frame 16.

In several embodiments, each sensor 106 may be configured as a pressure sensor 108. In general, the pressure sensor(s) 108 may be configured to detect or measure the pressure of a fluid supplied within the corresponding actuator(s) 102, 104. For example, in one embodiment, each pressure sensor 108 may be provided in fluid communication with a fluid chamber defined within the corresponding actuator 102, 104 (e.g., a piston-side chamber or a rod-side chamber of the corresponding actuator 102, 104). Alternatively, the pressure sensor(s) 108 may be installed at any other suitable location(s) that allows the pressure sensor(s) 108 to measure the pressure of the fluid supplied within the actuators 102, 104, such as by installing the pressure sensor(s) 108 in fluid communication with a hose(s) or a conduit(s) configured to supply fluid to the actuators 102, 104. The pressure of the fluid supplied within the actuators 102, 104 may, in turn, be indicative of the force exerted on the shanks 30, 32 by the soil through which the shanks 102, 104 are being pulled. However, it should be appreciated that, in alternative embodiment, the sensor(s) 106 may correspond to any suitable type of sensor(s) that detect the forces within one or more of actuators 102, 104 or otherwise associated with the shanks 30, 32.

It should be appreciated that the configuration of the tillage implement 10 described above and shown in FIGS. 1 and 2 is provided only to place the present subject matter in an exemplary field of use. Thus, it should be appreciated that the present subject matter may be readily adaptable to any manner of implement configuration.

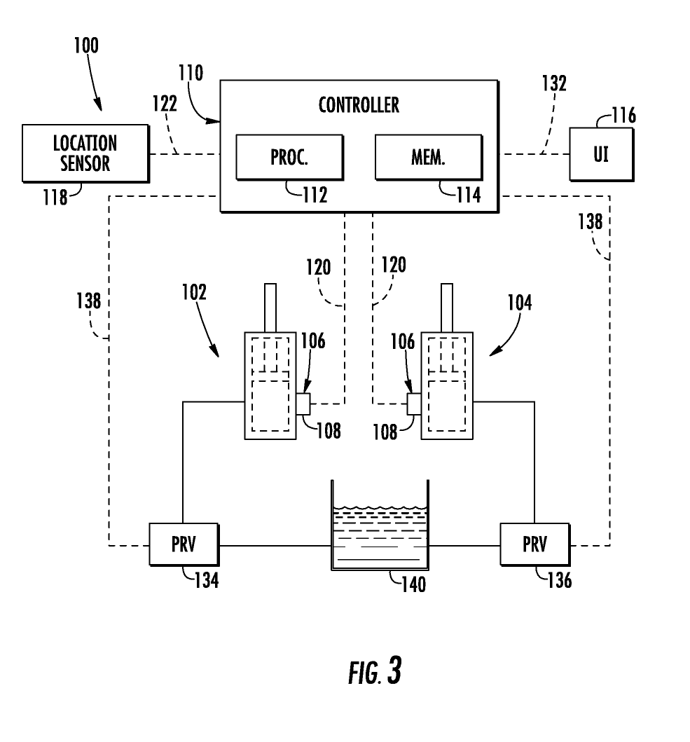

Referring now to FIG. 3, a schematic view of one embodiment of a system 100 for creating a soil compaction map for a field is illustrated in accordance with aspects of the present subject matter. In general, the system 100 will be described herein with reference to the tillage implement 10 described above with reference to FIGS. 1 and 2. However, it should be appreciated by those of ordinary skill in the art that the disclosed system 100 may generally be utilized with tillage implements having any other suitable implement configuration.

As shown in FIG. 3, the system 100 may include one or more components of the tillage implement 10 described above with reference to FIGS. 1 and 2. For example, in several embodiments, the system 100 may include the fluid-driven actuator(s) 102, 104 and the associated sensors 106, such as the pressure sensors 108. However, it should be appreciated that the system 100 may include any other suitable components of the implement 10, such as additional shanks and their associated actuators and sensors.

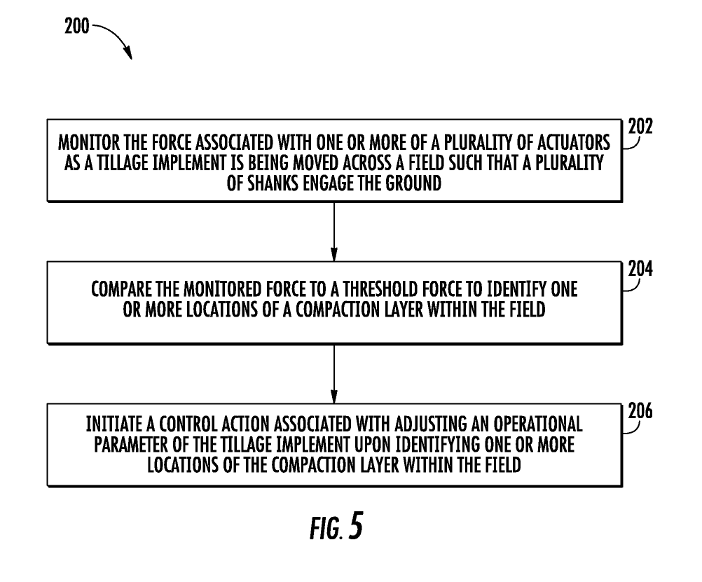

Moreover, the system 100 may further include a controller 110 configured to electronically control the operation of one or more components of the implement 10. In general, the controller 110 may comprise any suitable processor-based device known in the art, such as a computing device or any suitable combination of computing devices. Thus, in several embodiments, the controller 110 may include one or more processor(s) 112 and associated memory device(s) 114 configured to perform a variety of computer-implemented functions. As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory device(s) 114 of the controller 110 may generally comprise memory element(s) including, but not limited to, a computer readable medium (e.g., random access memory (RAM)), a computer readable non-volatile medium (e.g., a flash memory), a floppy disk, a compact disc-read only memory (CD-ROM), a magneto-optical disk (MOD), a digital versatile disc (DVD) and/or other suitable memory elements. Such memory device(s) 114 may generally be configured to store suitable computer-readable instructions that, when implemented by the processor(s) 112, configure the controller 110 to perform various computer-implemented functions, such as one or more aspects of the method 200 described below with reference to FIG. 5. In addition, the controller 110 may also include various other suitable components, such as a communications circuit or module, one or more input/output channels, a data/control bus and/or the like.

It should be appreciated that the controller 110 may correspond to an existing controller of the implement 10 or an associated work vehicle (not shown) configured to tow the implement 10 or the controller 110 may correspond to a separate processing device. For instance, in one embodiment, the controller 110 may form all or part of a separate plug-in module that may be installed within the implement 10 or the work vehicle to allow for the disclosed system and method to be implemented without requiring additional software to be uploaded onto existing control devices of the implement 10.

Furthermore, in one embodiment, the system 100 may also include a user interface 116. More specifically, the user interface 116 may be configured to provide feedback (e.g., a soil compaction map) to the operator of the implement 10. As such, the user interface 116 may include one or more feedback devices (not shown), such as display screens, speakers, warning lights, and/or the like, which are configured to communicate such feedback. In addition, some embodiments of the user interface 116 may include one or more input devices (not shown), such as touchscreens, keypads, touchpads, knobs, buttons, sliders, switches, mice, microphones, and/or the like, which are configured to receive user inputs from the operator. In one embodiment, the user interface 116 may be positioned within a cab of a work vehicle configured to tow the implement 10. However, in alternative embodiments, the user interface 116 may have any suitable configuration and/or be positioned in any other suitable location.

Additionally, the system 100 may include a location sensor 118 configured to detect a parameter associated with a geographical or physical location of the implement 10 within the field. For example, in one embodiment, the location sensor 118 may correspond to a GPS receiver configured to detect the GPS coordinates of the implement 10. However, it should be appreciated that the location sensor 118 may correspond to any other suitable type of location sensor.

In several embodiments, the controller 118 may be configured to receive data indicative of the forces detected in association with the actuators 102, 104 from the sensors 106. Specifically, the controller 110 may be communicatively coupled to the sensors 106, such as the pressure sensors 108, via a wired or wireless connection to allow data (e.g., indicated by dashed lines 120 in FIG. 3) to be transmitted from the sensors 106 to the controller 110. For example, in one embodiment, the controller 110 may be configured to continuously receive the data 120 from the sensors 106 as the implement 10 is moved through the field.

The controller 110 may be configured to identify one or more locations of a soil compaction layer within the field based on the sensor data 120. Specifically, in several embodiments, the controller 110 may be configured determine or estimate the forces exerted on each of the shanks 30, 32 by the soil based on the data 120 received from the corresponding sensor 106 (e.g., the corresponding pressure sensor 108). For instance, the controller 110 may include a look-up table or suitable mathematical formula stored within its memory 114 that correlates the sensor data 118 (e.g., the pressure measurements from the sensors 108) to the current forces being applied to shanks 30, 32. Thereafter, based on the determined forces exerted on each shank 102, 104, the controller 110 may be configured to identify the location(s) of the compaction layer within the field. It should be appreciated that, in alternative embodiments, the controller 110 may be configured identify the soil compaction layers directly based on the sensor data 120. For example, the controller 110 may include a look-up table or suitable mathematical formula stored within its memory 114 that correlates the sensor data 118 (e.g., the pressure measurements from the sensors 108) to the presence of a soil compaction layer.

In one embodiment, the controller 110 may be configured to identify location(s) of the soil compaction layer within the field by comparing the determined forces to a predetermined threshold force. For instance, the controller 110 may be configured to compare the values associated with the monitored forces for each actuator 102, 104 to a predetermined threshold force defined for the actuators 102, 104. In the event that the monitored force(s) associated with one or more of the actuators 102, 104 exceeds the predetermined threshold force (thereby indicating that the corresponding shank 30, 32 is currently being pulled through a soil compaction layer), the controller 110 may be configured to identify the position of such shank(s) 30, 32 within the field as a location of the soil compaction layer.

In accordance with aspects of the present subject matter, the controller 110 may further be configured to create a soil compaction map for the field based on the identified location(s) of the compaction layer. In general, the soil compaction map may provide an indication of the geographical or physical location(s) within the field in which the soil compaction layer is present. Specifically, the controller 110 may be communicatively coupled to the location sensor 118 via a wired or wireless connection to allow location data (e.g., indicated by dashed line 122 in FIG. 3) to be transmitted from the location sensor 118 to the controller 110. Based on the received location data 122, the controller 110 may be configured to monitor the geographical position of the implement 10 within the field. In this regard, when it is determined that one of the shanks 30, 32 of the implement 10 is currently being pulled through or otherwise encountering a soil compaction layer, the controller 110 may be configured to associate the current location or position of the implement 10 or the shanks 30, 32 within the field as one location of the soil compaction layer.

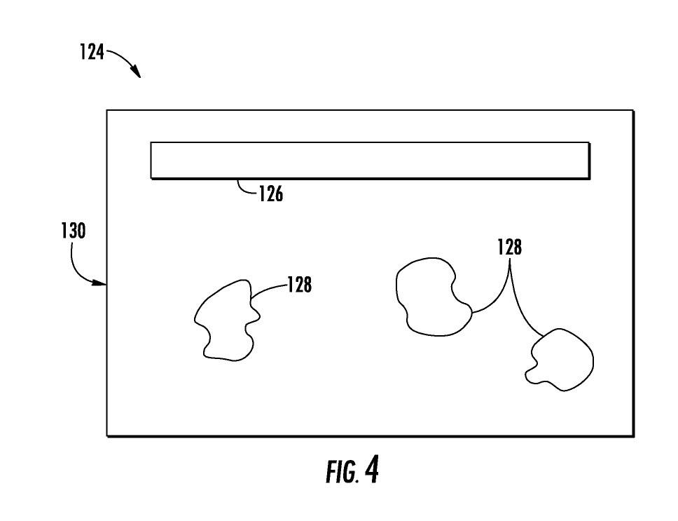

Referring now to FIG. 4, an example soil compaction map 124 is illustrated in accordance with aspects of the present subject matter. As shown, the soil compaction map 124 generally provides an indication (e.g., a visual indicator) of one or more locations of the soil compaction layer 126, 128 within a field 130. Based on the map 124, the farmer may be able to determine why the soil compaction layers 126, 128 are present in certain portions of the field 128 and choose to perform suitable corrective action(s) thereon. For example, the soil compaction layer 126 may be caused by heavy vehicle traffic. In such instances, the farmer may choose to redirect future traffic to minimize or eliminate the formation of such compaction layer 126. The compaction layers 128 may be formed by ponding or water retention. In such instances, the farmer may choose perform extra tillage operations on such areas and/or use a larger tillage implement to remove such soil compaction layers 128. Conversely, based on the map 124, the farmer may choose to forgo tillage operations on areas of the field 130 that are devoid of the compaction layers 126, 128. Furthermore, in one embodiment, the soil compaction map 124 may provide an indication of the depth of the soil compaction layers 126, 128 and/or the penetration depths of the shanks 30, 32 at each location within the field 130. Additionally, the soil compaction map 124 may provide an indication of the forces exerted on the shanks 30, 32 per unit of penetration depth to assist the implement operator in determining the appropriate penetration depth and/or implement speed for future tillage operations.

Referring again to FIG. 3, in one embodiment, the controller 110 may be configured to initiate the display of the soil compaction map to the operator of the implement 10 as the implement 10 is moved across the field. Specifically, the controller 110 may be communicatively coupled to the user interface 116 via a wired or wireless connection to allow feedback signals (e.g., indicated by dashed line 132 in FIG. 3) to be transmitted from the controller 110 to the user interface 116. Based on such feedback signals, the user interface 116 may be configured to display the soil compaction map to the implement operator. For example, the soil compaction map displayed by the user interface 116 may be continuously updated in real time as the implement 10 is moved across the field. It should be appreciated that as an alternative to or in addition to displaying the soil compaction map as the implement 10 is moving across the field, the map may be saved for future use (e.g., in the memory 114) and/or transmitted to a remote device, such as a PC, tablet, Smartphone, and/or the like.

In several embodiments, upon identifying one or more locations of the compaction layer within the field, the controller 110 may configured to initiate one or more control actions associated with adjusting an operational parameter(s) of the implement 10. For example, in such instances, the controller 110 may be configured to automatically control the operation of one or more components of the implement 10 and/or an associated work vehicle (not shown), such as the vehicle's engine or transmission, in a manner that reduces the ground speed of the implement 10 and/or the work vehicle (e.g., by reducing or limiting the engine power output). In general, reducing the speed at which the implement 10 is traveling across the field may reduce the forces exerted on the shanks 30, 32 by the soil. In this regard, reducing the implement speed may prevent the shanks 30, 32 from pivoting away from their predetermined shank positions (e.g., to a shallower depth of penetration), thereby facilitating removal of the entire soil compaction layer within the field.

Furthermore, in several embodiments, upon identifying one or more locations of the compaction layer within the field, the controller 110 may be configured to automatically adjust the down pressure exerted on the shanks 30, 32 by the corresponding actuators 102, 104 to maintain the desired penetration depth thereof. Specifically, as shown in FIG. 3, the controller 110 maybe configured to control the operation of the actuators 102, 104 by actively controlling the operation of associated valves 134, 136, such as pressure regulating valves (PRVs), of the implement 10, thereby allowing the controller 110 to actively adjust the adjust the down pressure exerted on the shanks 30, 32. For example, in the illustrated embodiment, the controller 110 may be communicatively coupled to valves 134, 136 to allow control signals (e.g., indicated by dashed lines 138 in FIG. 3) to be transmitted from the controller 110 to the valves 134, 136. In this regard, the controller 110 may be configured to control the operation of the valves 134, 136 in a manner that regulates the pressure of the hydraulic fluid supplied to the associated actuator 102, 104 from a reservoir 140 of the implement 10. In such an embodiment, the controller 110 may be configured to control the operation of the PRV 134 such that the fluid pressure supplied to the actuator 102 is increased when it is determined that the shank 30 is being pulled through a soil compaction layer. Increasing the fluid pressure within the actuator 102 may increase the down pressure on the shank 30, which, in turn, may prevent or reduce the amount that the shank 30 pivots away from its predetermined shank position, thereby maintaining the desired penetration depth. Similarly, the controller 110 may be configured to control the operation of the PRV 136 such that the fluid pressure supplied to the actuator 104 is increased when it is determined that the shank 32 is being pulled through a soil compaction layer. Increasing the fluid pressure within the actuator 104 may increase the down pressure on the shank 32, which, in turn, may prevent or reduce the amount that the shank 32 pivots away from its predetermined shank position, thereby maintaining the desired penetration depth.

Additionally, in one embodiment, the controller 110 may be configured to automatically adjust the penetration depths of the shanks 102, 104 to prevent damage to the implement 10. Specifically, the controller 110 may be configured to compare the monitored forces associated with the actuators 102, 104 to a threshold force (e.g., the same threshold force to identify the soil compaction layer or a greater force threshold). Thereafter, in the event that the monitored forces associated with the actuators 102, 104 exceed threshold force, the controller 110 may be configured to automatically adjust the penetration depths of the shanks 102, 104 to prevent damage to the implement 10. In such embodiment, the pressure of the fluid supplied from the valve 134 may be directly proportional to the amount of extension/retraction of the actuator 102, thereby allowing the controller 110 to control the displacement of the actuator 102 and, in turn, the penetration depth of the shank 102. Similarly, the pressure of the fluid supplied from the valve 136 may be directly proportional to the amount of extension/retraction of the actuator 104, thereby allowing the controller 110 to control the displacement of the actuator 104 and, in turn, the penetration depth of the shank 104. In the event that the penetration depths of the shanks 30, 32 are reduced, the controller 110 may be configured identify the location(s) within the field at which such shank penetration depth reduction(s) occurred (e.g., on the soil compaction map). In this regard, the operator may choose to till such areas a second to time to achieve the desired penetration as partially tilled soil generally exerts less forces on the shanks 30, 32. As an alternative, the controller 110 may automatically control the operation of the associated work vehicle such that the areas of the field where such shank penetration depth reduction(s) occurred are tilled a second time to ensure desired tillage depth is reached.

It should be appreciated that, in several embodiments, the controller 110 may be configured to selectively the operation of each actuator 102, 104 based on whether its respective shank 30, 32 is currently positioned within a soil compaction layer. More specifically, in certain instances, it may be determined that one of the shanks 30, 32 is being pulled through a soil compaction layer, while the other shank 30, 32 is not. That is, the soil compaction layer may extend across only a portion of the lateral width of the implement 10. In such instances, the controller 110 may be configured to transmit control signals 138 to the valve 134, 136 corresponding to the shank 30, 32 positioned within the soil compaction layer instructing such valve 134, 136 to adjust the down pressure exerted on or the penetration depth of its respective shank 30, 32 as described above. Furthermore, the controller 138 may be configured to maintain the down pressure exerted on or the penetration depth of the other shank 30, 32, which is not positioned within the soil compaction layer.

Referring now to FIG. 5, a flow diagram of one embodiment of a method 200 for controlling the operation of a tillage implement is illustrated in accordance with aspects of the present subject matter. In general, the method 200 will be described herein with reference to the tillage implement 10 and the system 100 described above with reference to FIGS. 1-4. However, it should be appreciated by those of ordinary skill in the art that the disclosed method 200 may generally be utilized to control the operation of any tillage implement having any suitable implement configuration and/or system having any other suitable system configuration. In addition, although FIG. 5 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 5, at (202), the method 200 may include monitoring, with a computing device, a force associated with one or more of the plurality of actuators as the tillage implement is being moved across a field such that the shanks engage the ground. For instance, as described above, the controller 110 may be communicatively coupled to one or more sensors 106, such as one or more pressure sensor 108, configured to capture data 120 indicative of the forces associated with the actuator 102, 104 provided in operative association with each shank 30, 32 of the implement 10, thereby providing an indication of the force being applied through each shank 30, 32. As such, data 120 transmitted from the sensors 106 may be received by the controller 110 and subsequently analyzed and/or processed to determine the forces associated with the various shanks 30, 32 of the implement 10 as the shanks 30, 32 are being pulled through the ground.

Additionally, at (204), the method 200 may include comparing, with the computing device, the monitored force to a threshold force to identify one or more locations of a compaction layer within the field. For instance, as described above, the controller 110 may be configured to compare the monitored forces to a predetermined threshold force value. Assuming the monitored force(s) has exceeded the force threshold, the controller 110 may identify the portion(s) of the field at which the implement 10 is positioned as a location of a soil compaction layer.

Moreover, as shown in FIG. 5, at (206), the method 200 may include initiating, with the computing device, a control action associated with adjusting an operational parameter of the tillage implement upon identifying one or more locations of the compaction layer within the field. As described above, such control actions may include controlling one or more components of the implement 10 and/or the associated work vehicle (not shown). For instance, as indicated above, the controller 110 may be configured to automatically initiate a control action that results in the ground speed of the implement 10 and/or the work vehicle being reduced, such as by automatically controlling the operation of the vehicle's engine and/or transmission. Moreover, as described above with reference to FIG. 3, the controller 110 may also be configured to actively regulate the pressure of the fluid supplied within the associated actuators 102, 104 (e.g., by electronically controlling the associated PRVs 134, 136) to adjust the down pressure applied to and/or the penetration depths of the shanks 30, 32.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A system for creating a soil compaction map for a field, the system comprising:
a tillage implement including a frame and a plurality of shanks coupled to the frame, the tillage implement further including a plurality of fluid-driven actuators, each fluid-driven actuator being coupled between the frame and a respective one of the plurality of shanks;
a plurality of sensors, each sensor being provided in operative association with a respective one of the plurality of fluid-driven actuators, each sensor being configured to detect a force associated with its respective fluid-driven actuator as the shanks engage the ground with movement of the tillage implement across the field; and
a controller communicatively coupled to the plurality of sensors, the controller being configured to identify one or more locations of a compaction layer within the field based on sensor data received from the plurality of sensors associated with the detected forces, the controller further being configured to create a soil compaction map for the field based on the identified one or more locations of the compaction layer.

2. The system of claim 1, wherein the controller is further configured to identify the one or more locations of the soil compaction layer by comparing the monitored force associated with each fluid-driven actuator to a threshold force, the soil compaction map associating the one or more locations of the soil compaction layer with each location within the field at which the monitored force exceeds the force threshold.

3. The system of claim 2, wherein the controller is further configured to initiate a control action associated with adjusting an operational parameter of the tillage implement when the monitored force associated with one or more of the actuators exceeds the threshold force.

4. The system of claim 3, wherein the control action is associated with adjusting a speed at which the tillage implement is being moved across the field.

5. The system of claim 3, wherein the control action is associated with adjusting a penetration depth of one or more of the plurality of shanks when the monitored forces associated with their respective actuators exceeds the threshold force.

6. The system of claim 1, wherein the soil compaction map provides an indication of a penetration depth of the plurality of ground engaging shanks at each location within the field.

7. The system of claim 1, wherein one or more of the plurality of sensors comprise a pressure sensor configured to detect a fluid pressure within its respective fluid-driven actuator.

8. The system of claim 1, wherein the controller is configured to initiate display of the soil compaction map to an operator of the tillage implement as the tillage implement is being moved across the field, the soil compaction map providing a visual indicator of the one or more locations of the soil compaction layer across the field.

9. A method for controlling the operation of a tillage implement, the tillage implement including a frame and a plurality of shanks coupled to the frame, the tillage implement further including a plurality of fluid-driven actuators, each fluid-driven actuator being coupled between the frame and a respective one of the plurality of shanks, the method comprising:
monitoring, with a computing device, a force associated with one or more of the plurality of actuators as the tillage implement is being moved across a field such that the shanks engage the ground;
comparing, with the computing device, the monitored force to a threshold force to identify one or more locations of a compaction layer within the field; and
initiating, with the computing device, a control action associated with adjusting an operational parameter of the tillage implement upon identifying one or more locations of the compaction layer within the field.

10. The method of claim 9, wherein the control action is associated with adjusting the operational parameter in a manner that facilitates removal of the compaction layer within the field.

11. The method of claim 9, wherein the control action is associated with adjusting a speed at which the tillage implement is being moved across the field.

12. The method of claim 9, wherein the control action is associated with adjusting a penetration depth of one or more of the plurality of shanks when the monitored forces associated with their respective actuators exceeds the threshold force.

13. The method of claim 9, further comprising:
creating, with the computing device, a soil compaction map for the field based on the identified one or more locations of the compaction layer.

14. The method of claim 12, wherein the soil compaction map associates the one or more locations of the soil compaction layer with each location within the field at which the monitored force exceeds the force threshold.

15. The method of claim 12, wherein the soil compaction map provides an indication of a penetration depth of the plurality of ground engaging shanks at each location with the field.

16. The method of claim 9, wherein monitoring the force associated with the one or more of the plurality of actuators comprises monitoring, with the computing device, the force associated with the one or more of the plurality of actuators based on sensor data received from a plurality of pressure sensors, each pressure sensor being provided in operative association with a respective one of the plurality of fluid-driven actuators, each pressure sensor being configured to detect a force associated with its respective fluid-driven actuator as the shanks engage the ground with movement of the tillage implement across the field.

17. The method of claim 9, further comprising:
initiating, with the computing device, display of the soil compaction map to an operator of the tillage implement as the tillage implement is being moved across the field, the soil compaction map providing a visual indicator of the one or more locations of the soil compaction layer across the field.
